(19) United States
(12) Patent Application Publication
(10) Pub. No.: US 2009/0083150 A1
(43) Pub. Date: Mar. 26, 2009

(54) Method, system and apparatus for dynamic advertisement delivery

(75) Inventor: Alex Mashinsky, Memphis, TN (US)

Correspondence Address: COHEN, PONTANI, LIEBERMAN & PAVANE LLP, 551 FIFTH AVENUE, SUITE 1210, NEW YORK, NY, 10176, US

(73) Assignee: Governing Dynamics, LLC, New York, NY (US)

(21) Appl. No.: 11/918,794

(22) PCT Filed: Apr. 25, 2006
(86) PCT No.: PCT/US06/15381

§ 371 Date: Oct. 17, 2007

Related U.S. Application Data
(60) Provisional application No. 60/674,704, filed on Apr. 26, 2005.

(51) Int. Cl. G07G 1/14

(52) U.S. Cl. 705/14

(57) ABSTRACT

A method, system and apparatus for the dynamic delivery of voice and video advertisements to stores, billboards O and movie screens is provided. The inventory of advertisements is managed from a centralized location and can be accessed directly or via a global network, such as, for example, the internet. Other items that may be incorporated into the inventory include bulletins, messages, and other entertainment media. Checkout information is gathered in stored and fed back into the system so that users can see the real-time effects of advertising campaigns. Users may also modify advertising campaigns in response to the real time checkout data in order to gain maximum benefit from the campaign.

### CROSS REFERENCE TO RELATED APPLICATIONS

This application claims priority from U.S. Provisional Application Ser. No. 60/674,704, filed Apr. 26, 2005.

### BACKGROUND OF THE INVENTION

1. Field of the Invention

The present invention relates generally to advertisement placement. More particularly, it relates to a system and method for the delivery of dynamic audio and video advertisements to stores, billboards, and movie screens with inventory management control at the seller (publisher) or buyer (advertiser) level.

2. Description of Related Art

Many advertisers spend increasing amounts of their budgets directed to advertising at the point of sale. Presently, these sales or promotions are conducted statically. That is, they are not dynamic in both their ability to be changed, and/or the ability to received feedback as to the effectiveness of such point of sale advertising. Distributing an advertisement on billboards, buses and television clearly does not allow for fast, effective reliable feedback collection. As a matter of fact, there are very few accurate ways to track the sales relating to a billboard or other static advertisement. As such, determining the length or scope of such an advertisement can be a significant gamble for advertisers or buyers of the ad space. As mentioned above, it is very difficult to measure the efficacy of a specific ad campaign in a short time. After conducting a traditional advertisement campaign, the advertiser may analyze sales data to determine if the advertisement campaign can be correlated to the sales data and, if so, whether the advertising campaign had a positive or negative effect. There may not be a correlation of sale increases/decreases with the specific content of advertisements or with a particular set of distribution parameters. Further, a time lag exists between conducting the advertisement campaign and obtaining any reliable results or feedback about the success of the campaign.

There are currently no systems available that enables the advertisers (buyers of ad space) and/or sellers of the ad space to collect dynamic real time feedback relating to the point of sale advertisements being purchases by the buyers. This feedback is then disseminated to interested parties (e.g., sellers, buyers, product manufactures, product promotion mangers, store managers, etc.) which allow the same to dynamically change the ad pricing, placement, time of delivery, etc. as it pertains to the respective campaign. Consequently, there is a need for a system where all interested parties can obtain dynamic feedback information relating to each and every advertising campaign, and allow them to dynamically change the same to optimize their sale conversions for each advertising campaign.

### SUMMARY OF THE INVENTION

The system and method of the present principles addresses the above problems by collecting dynamic information on sales and promotions from a number of sellers. A Dynamic Advertisement Delivery Network (DADN), generally contains audio and video advertisements stored by advertisers. Remote sales reporting nodes (RSRN) collect sales data related to the distributed advertisements. Advertisers may analyze the collected sales data and distribute the advertisements on a schedule based on the collected sales data. Accordingly, the system enables focused and dynamic delivery of ads to specific stores and regions within stores or other establishments and allows a targeted and dynamic execution of marketing strategies. Advertisement campaign management may be conducted from a centralized location with interaction between managers and advertisement campaign personnel.

According to one aspect of the present principles, the DADN is connected to a plurality of media players located within retail establishments in areas where purchase decisions are made by consumers. Such players are connected to the DADN via IP networks with dialup, dedicated or wireless connectivity. The media players may have the ability to convert files into audio or video feeds, and can include a local storage having an internal inventory of advertisements and other entertainment mediums. Further, the media player may have internal programming with a schedule providing detailed distribution protocols specifying where and when to run the advertisements. According to another aspect, the media player can initiate or be contacted by the DADN for updates of the schedule or the content advertisements to be played.

The media players are connected to one or multiple audio and/or video networks inside the stores, and may have UWB (Ultra Wideband) Wi-Fi (wireless fidelity) or other local wireless capabilities. The UWB connection can be used to transmit, advertisements or price information in advertising venues. By way of example only, the media players may distribute advertisements on store shelves or on screens installed in shopping carts corresponding to audio played locally or throughout a store or corresponding to the customer's location with in the store or retail establishment.

Another aspect of the present principles relates to a duality of advertising management capabilities. By way of example only, both a Chain/Store Manager, as an ordinary company employee, and an Advertising Executive, hired by the company for a specific advertising campaign, working either in coordination or independently may manipulate the system, via the DADN controller. The DADN provides access to any of the above entities that are connected via the Internet or private networks to on a very broad scale. The user may decide distribution policies for advertising campaigns locally in one aisle of a store, over an entire store, for an entire chain, or for the entire distribution line of the product, by accessing the database and changing the advertising distribution characteristics associated with a specific advertising campaign. By collecting sales data and reporting it back to the DADN, store owners and advertisers can collect immediate feedback regarding the success or progress of advertising campaigns directed to specific advertising characteristics. It is to be understood that some of these characteristics may be, but are not limited to time-specific campaigns, store specific campaigns, store department campaigns, i.e., sporting goods, pharmaceuticals, produce, or other departments.

In an alternate embodiment, store owners may register unoccupied advertising slots and specify what they want to charge for them. Non-contracted parties may purchase unoccupied advertising slots from the owners to promote their products. Accordingly, the DADN may be used to coordinate these transactions.

Furthermore, and according to another aspect of the present principles, the system may be linked to emergency services enabling the emergency service providers to notify the public of an emergency situation in a specific region.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is an exemplary diagram illustrating system elements associated with a Dynamic Advertisement Delivery Network (DADN) according to an embodiment of the present principles;

FIG. 2 is an exemplary system-level structure diagram illustrating the relationships between the Vendor, Store/Chain Managers, the DADN, and Advertising venues;

FIG. 3 is an exemplary operation diagram illustrating possible Advertiser activities;

FIG. 4 is an exemplary operation diagram of an Advertiser interacting with the DADN; and

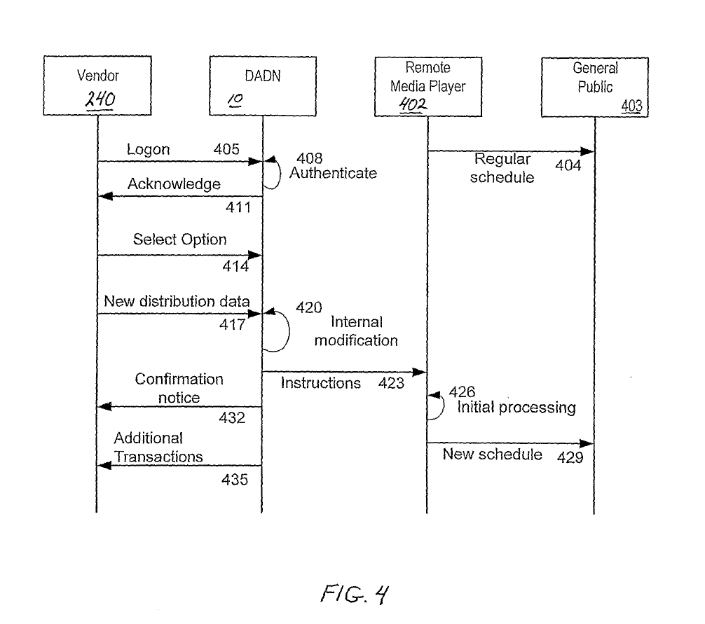

FIG. 5 is an exemplary operation diagram of an Emergency Services Unit utilizing the DADN.

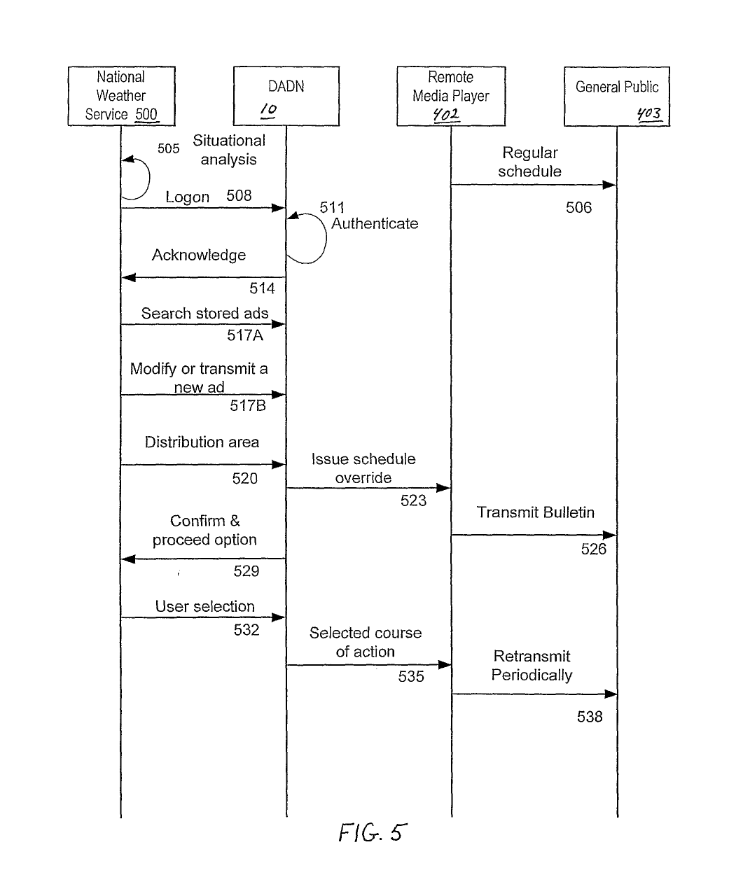

### DETAILED DESCRIPTION OF PREFERRED EMBODIMENTS

### Overview of System

The system of the present principles is adapted to accept advertisements deposited by Advertisers and display them on media players located in and throughout participating stores. The advertisements may be distributed in a specific area within advertising venues, for example throughout a store or in a chain of many stores. The dynamic advertising delivery network (DADN) uses remote sales reporting nodes (RSRN) to collect sales data from the advertising venues and transmits that data back to the Advertiser. The Advertiser can modify the advertisements or distribution schedule based on an analysis of the reported sales data. This creates a dynamic exchange where the effect of advertising is seen in real time and related modifications can be made in real time as well. It is to be understood that users of the DADN may include Vendors, Store Managers, Chain Managers and/or any other entity who wants to advertise goods or services. The DADN database may be accessible by users through direct connection to a central server or through the internet.

### Dynamic Advertisement Delivery Network (DADN)

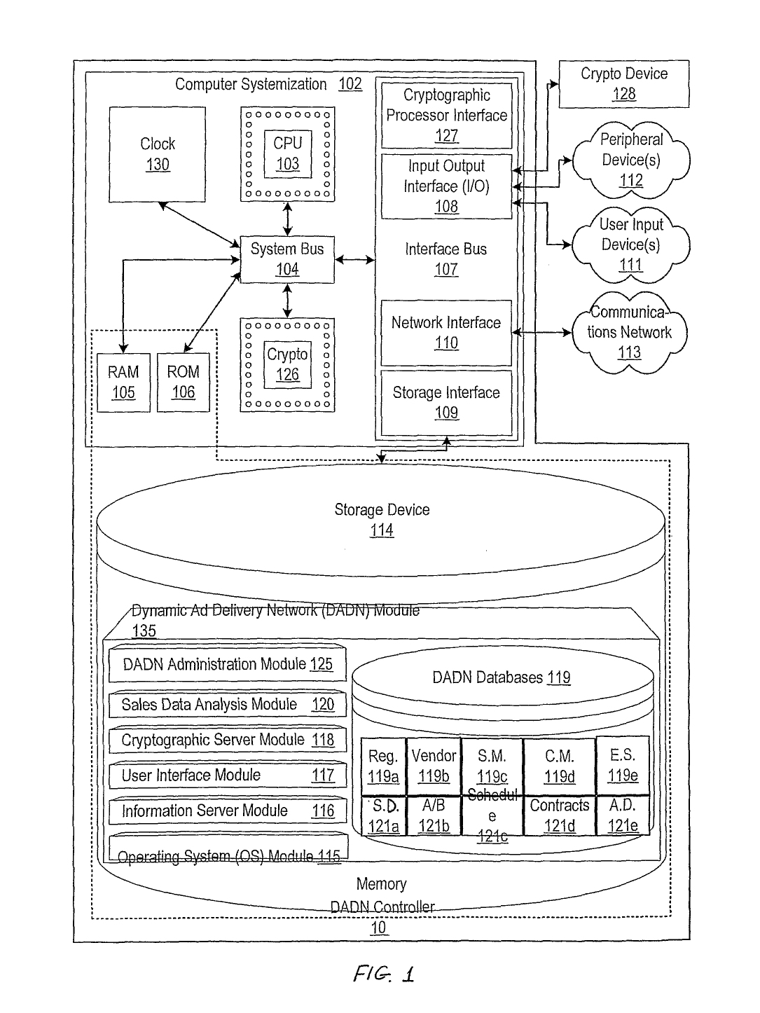

FIG. 1 is an exemplary diagram illustrating system elements associated with a Dynamic Advertisement Delivery Networking (DADN) System according to an embodiment of the present principles. In this embodiment, the DADN controller 10 may serve to receive, process, store, transmit, schedule and analyze messages or instructions associated with different aspects of the general advertiser process from a vendor, sales manager, chain manager, advertising executive, other system user, or advertising venue.

In one embodiment, the DADN controller 10 may be connected to and/or communicate with entities such as, but not limited to: one or more users from user input devices 111; peripheral devices 112; and/or a communications network 113. Further, the DADN controller 10 may be connected to and/or communicate with a cryptographic processor device 128.

A typical DADN controller 10 may be based on common computer systems that may comprise, but are not limited to, components such as: a computer systemization 102 connected to memory 129.

It is to be understood that the system of the present principles may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (10/) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

### Computer Systemization

Computer systemization 102 may comprise a clock 130, central processing unit (CPU) 103, a read only memory (ROM) 106, a random access memory (RAM) 105, and/or an interface bus 107, and conventionally, although not necessarily, are all interconnected and/or communicate through a system bus 104. The system clock 130 typically has a crystal oscillator and provides a base signal. The clock 130 is typically coupled to the system bus and has various means that will increase or decrease the base operating frequency for other components interconnected in the computer systemization. The clock 130 and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Optionally, a cryptographic processor 126 may similarly be connected to the system bus. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as the Intel Pentium Processor and/or the like. The CPU interacts with memory through signal passing through conductive conduits to execute stored program code according to conventional data processing techniques. Such signal passing facilitates communication within the DADN controller and other connected devices through various interfaces.

### Interface Adapters

Interface bus(ses) 107 may accept, connect, and/or communicate to a number of interface adapters, conventionally although not necessarily in the form of adapter cards, such as but not limited to: input output interfaces (I/O) 108, storage interfaces 109, network interfaces 110, and/or the like. Optionally, cryptographic processor interfaces 127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (PCI), Personal Computer Memory Card International Association (PCMCIA), and/or the like.

Storage interfaces 109 may accept, communicate, and/or connect to a number of storage devices such as, but not limited to: storage devices 114, removable disc devices, and/or the like. Storage interfaces may employ connection protocols such as, but not limited to: (Ultra) Advanced Technology Attachment (Packet Interface) ((Ultra) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 110 may accept, communicate, and/or connect to a communications network 113. Network interfaces may employ connection protocols such as, but not limited to: direct connect, Ethernet (thick, thin, twisted pair 10/100/1000 Base T, and/or the like), Token Ring, wireless connection such as IEEE 802.11b, and/or the like. A communications network may be any one and/or the combination of the following: a direct interconnection; the Internet; a Local Area Network (LAN); Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface.

Input Output interfaces (I/O) 108 may accept, communicate, and/or connect to user input devices 111, peripheral devices 112, cryptographic processor devices 128, and/or the like. I/O may employ connection protocols such as, but not limited to: APPLE Desktop Bus (ADB); APPLE Desktop Connector (ADC); audio: analog, digital, monaural, RCA, stereo, and/or the like; IEEE 1394; infrared; joystick; keyboard; midi; optical; PC AT; PS/2; parallel; radio; serial; USB; video interface: BNC, composite, digital, RCA, S-Video, VGA, and/or the like; wireless; and/or the like. A common output device is a video display, which typically comprises a CRT or LCD based monitor with an interface (e.g., VGA circuitry and cable) that accepts signals from a video interface. The video interface composites information generated by a computer systemization and generates video signals based on the composite information. Typically, the video interface provides the composite video information through a video connection interface that accepts a video display interface (e.g., a VGA connector accepting a VGA display cable).

User input devices 111 may be card readers, dongles, finger print readers, gloves, graphics pads, joysticks, keyboards, mouse (mice), trackballs, trackpads, retina readers, and/or the like.

Peripheral devices 112 may be connected and/or communicate with or to I/O and/or with or to other facilities of the like such as network interfaces, storage interfaces, and/or the like). Peripheral devices may be cameras, dongles (for copy protection, ensuring secure transactions as a digital signature, and/or the like), external processors (for added functionality), goggles, microphones, monitors, network interfaces, printers, scanners, storage devices, visors, and/or the like.

Cryptographic units such as, but not limited to, microcontrollers, processors 126, interfaces 127, and/or devices 128 may be attached, and/or communicate with the DADN controller 10. By way of example, a MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 284.

### Memory

A storage device 114 may be any conventional computer system storage. Storage devices may be a fixed hard disk drive, and/or other devices of the like. However, it is to be understood that a DADN controller 10 and/or a computer systemization may employ various forms of memory 129. For example, a computer systemization may be configured wherein the functionality of on chip CPU memory (e.g., registers), RAM, ROM, and any other storage devices are provided by a paper punch tape or paper punch card mechanism; of course such an embodiment is not preferred and would result in an extremely slow rate of operation. In a typical configuration, memory 129 will include ROM, RAM, and a storage device 114. Generally, any mechanization and/or embodiment allowing a processor to affect the storage and/or retrieval of information is regarded as memory 129. Thus, a computer systemization generally requires and makes use of memory. However, memory is a fungible technology and resource. Thus, any number of memory embodiments may be employed in lieu of or in concert with one another without departing from the spirit of the present principles.

### DADN Module Collection

The storage devices 114 may contain a collection of program and/or database modules and/or data such as, but not limited to: an operating system module 115 (operating system); an information server module 116 (information server); a user interface module 117 (user interface); a sales data analysis module 120 (user analysis module); databases 119; a cryptographic server module 118 (cryptographic server); DADN Administration module 125; and/or the like (i.e., collectively a module collection). These modules may be stored and accessed from the storage devices and/or from storage devices accessible through an interface bus. Although non-conventional software modules such as those in the module collection, are typically stored in a local storage device 114, they may also be loaded and/or stored in memory such as: peripheral devices, RAM, remote storage facilities through a communications network, ROM, various forms of memory, and/or the like.

### Operating System

The operating system module 115 is executable program code facilitating the operation of a DADN controller 10. Typically, the operating system facilitates access of I/O, network interfaces, peripheral devices, storage devices, and/or the like. The operating system may be a conventional product such as Apple Macintosh OS X Server, AT&T Plan 9, Microsoft Windows NT Server, Unix, and/or the like operating systems. The operating system may be highly fault tolerant, scalable, and secure. An operating system may communicate to and/or with other modules in a module collection, including itself, and/or facilities of the like. Conventionally, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the DADN controller to communicate with other entities through a communications network 113. Various communication protocols may be used by the DADN controller during interactions with Advertisers, such as, but not limited to: multicast, TCP/IP, UDP, unicast, and/or the like.

### Information Server

An information server module 116 is stored program code that is executed by the CPU. The information server may be a conventional Internet information server such as, but not limited to, Microsoft's Internet Information Server and/or the Apache Software Foundation's Apache. In one embodiment, the information server allows for the execution of program modules through facilities such as C++, Java, JavaScript, ActiveX, Common Gateway Interface (CGI) scripts, Active Server Page (ASP), and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. Conventionally, an information server provides results in the form of web pages to web browsers, and allows for the manipulated generation of the web pages through interaction with other program modules. After a DNS resolution portion of an HTTP request is resolved to a particular information server, the information server resolves requests for information at specified locations on a DADN controller based on the remainder of the HTTP request. For example, a request such as http://123.124.125.126/Information.html might have the IP portion of the request “123.124.125.126” resolved by a DNS server to an information server at that IP address; that information server might in turn further parse the http request for the “/Information.html” portion of the request and resolve it to a location in memory containing the information “Information.html.” An information server may communicate to and/or with other modules in a module collection, including itself, and/or facilities of the like. Most frequently, the information server communicates with operating systems, other program modules, user interfaces, web browsers, and/or the like. An information server may contain, communicate, generate, obtain, and/or provide program module, system, user, and/or data communications, requests, and/or responses.

### User Interface

A user interface module 117 is stored program code that is executed by the CPU. The user interface may be a conventional graphic user interface as provided by, with, and/or atop operating systems and/or operating environments such as Apple Macintosh OS, e.g., Aqua, Microsoft Windows ˜NT), Unix X Windows (KDE, Gnome, and/or the like), and/or the like. The user interface may allow for the display, execution, interaction, manipulation, and/or operation of program modules and/or system facilities through textual and/or graphical facilities.

The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

### Sales Data Analysis (SDA)

A sales data analysis (SDA) module 120 is stored program code that is executed by the CPU. The sales data analysis module 120 receives sales data updates from remote sales reporting nodes (RSRNs) distributed across the network. In one embodiment, the sales data analysis module receives raw sales data which is automatically collected and forwarded to the DADN controller 10 by remote sales reporting nodes. In an alternate embodiment, the SDA module collects sales data reports that have been prepared by the remote sales reporting nodes (RSRN) 250 and forwards them to the DADN controller 10. The sales data analysis (SDA) module 120 parses the raw sales data, and extracts pertinent information for storage in the sales data (SD) database module 121a. Additionally, the sales data analysis node 120 works with the SD module 121a, and the user interface module 117 to provide Advertisers with access to the sales data to facilitate sales data analysis. Further, the SDA module 120 may be designed to communicate with the remote sales reporting nodes through messages. It is to be understood that the communication messages may be, but are not limited to any one specific message type. For example, the messages may be e-mail, SMS messages, automated information extraction service messages or any other data messages.

In a preferred alternative embodiment, the DADN 10 controller is also connected to third party networks/marketplaces where other dales data can be collected relating to a particular good or category of goods. This connection can be direct our through the internet or other networks. The DADN controller 10 is capable of collecting this third party sales data and storing the same in the Sales data database 121a so that such data is either combined with the RSRN provided data or separately managed by the SDA module 120 to enable the buyers and sellers of the point of sale media space to view real time feedback regarding the sales activity at the same.

### DADN Administration Module

A DADN administration module 125 is stored program code that is executed by the CPU. The DADN administration module 125 works in conjunction with the user interface module 117, and the DADN Databases 119, 121 in order to manage and update the contractual and account aspects for each of the DADN customers. The module may be used to present available advertising options for customers. Additionally, the DADN administration module 125 may work with the sales data analysis module 120 to incorporate current sales figures, reports, or analysis along with the available options presented to the customer.

### DADN Databases

Two DADN database modules 119 and 121 are illustrated in FIG. 1. The databases may be embodied in a database that is stored program code and executed by the CPU. The stored program code portion configures the CPU to process the data stored in the database. The databases may be conventional, fault tolerant, relational, scalable, secure databases such as Oracle or Sybase. Relational databases are an extension of a flat file and consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternately, the DADN databases may be implemented using various standard data structures, such as an array, hash, (linked) list, struct, table, and/or the like. Such data-structures may be stored in memory and/or in (structured) files. If the DADN databases are implemented as data-structures, the use of the DADN databases may be integrated into another module such as the DADN Administration 125 module. Databases may be consolidated and/or distributed in countless variations through standard data processing techniques. Portions of databases, e.g., tables, may be exported and/or imported and thus decentralized and/or integrated. In one non-limiting example embodiment, the database module 119 includes tables such as, a Registration table 119a (a listing of account numbers, log-in names, passwords and other information for identifying and authenticating registered users), Vendor tables 119b (a listing of Vendor maintained data), a listing of Store Manager maintained data (S.M.) tables 119c, a listing of Chain Manager maintained data (C.M.) tables 119d, Emergency Services (E.S.) databases 119e and/or the like.

The database module 121 includes tables such as, but not limited to, a Sales Data tables 121a (S.D.), Advertisement or Bulletin Database for storage (A/B) 121b, Scheduling Data Tables 121c, Contract Tables 121d, and the Advertisement Distribution (A.D.) database 121e, and/or the like.

In an alternate embodiment, these tables are capable of being decentralized into their own databases and their respective database controllers (i.e., individual database controllers for each of the above tables). Of course, employing standard data processing techniques, one may further distribute the databases over several computer systemizations and/or storage devices. Similarly, configurations of the decentralized database controllers may be varied by consolidating and/or distributing the various database modules 119a-e and 121a-e.

DADN databases may communicate to and/or with other modules in a module collection, including themselves, and/or facilities of the like. Most frequently, the DADN databases communicate with the DADN module, other program modules, and/or the like. The databases may contain, retain, and provide information regarding other nodes and data.

### Cryptographic Server

A cryptographic server module 118 is stored program code that is executed by the CPU 103, cryptographic processor 126, cryptographic processor interface 127, cryptographic processor device 128, and/or the like. Cryptographic processor interfaces will allow for expedition of encryption and/or decryption requests by the cryptographic module; however, the cryptographic module, alternatively, may run on a conventional CPU. In one exemplary embodiment, the cryptographic module allows for the encryption and/or decryption of provided data. The cryptographic module may provide both symmetric and asymmetric (e.g., Pretty Good Protection (PGP)) encryption and/or decryption. In another embodiment, the cryptographic module allows conventional cryptographic techniques such as, but not limited to: digital certificates (e.g., X.509 authentication framework), digital signatures, dual signatures, enveloping, password access protection, public key management, and/or the like. The cryptographic module may facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, RC5 (Rivest Cipher), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. The cryptographic module facilitates the process of “security authorization” whereby access to a resource is inhibited by a security protocol wherein the cryptographic module effects authorized access to the secured resource. A cryptographic module may communicate to and/or with other modules in a module collection, including itself, and/or facilities of the like. The cryptographic module may support encryption schemes allowing for the secure transmission of information across a communications network to enable a DADN module 135 to engage in secure transactions if so desired by users. The cryptographic module facilitates the secure accessing of resources on DADN and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

### Dynamic Advertisement Delivery Network (DADN)

The DADN module 135 is stored program code that is executed by the CPU. Generally, the DADN module facilitates a user's access and interaction with the system. The user may add to, delete, and/or modify the advertisements associated with their account. The user may enter an administration mode manipulating various parameters associated with their account. It is to be understood that some of these parameters may be, but are not limited to, current advertising venue locations, display schedules, advertisement frequency, or other parameters associated with service contracts. Further, the user may access specific sales data obtained from remote advertising venues, as transmitted by the remote sale data reporting module. The DADN module 135 interacts with the DADN database 119, 121 to provide the user access to the various types of data that are stored on the system. DADN enabled processing may be developed by employing standard development tools such as, but not limited to: C++, shell scripts, Java, Javascript, SQL commands, web application server extensions, Apache modules, Perl scripts, binary executables, and/or the like. In one non-limiting exemplary embodiment, the DADN employs a cryptographic server to encrypt and decrypt communications. The DADN controller 10 may catalog advertising content, service contracts, advertising venue information, sales data and much more.

The DADN module 135 may communicate to and/or with other modules in a module collection, including itself, and/or facilities of the like. The DADN module may implement UNI/NNI as a protocol manager for directing communications between different systems connected to the DADN. It is to be understood that other standards may be implemented for the protocol manager. Generally, the DADN module 135 communicates internally, with Advertisers, and with Advertising venues across a communications network with: a DADN database, an SDA module, operating systems, other program modules, and/or the like. The DADN may contain, communicate, generate, obtain, and/or provide program module, system, user, and/or data communications, requests, and/or responses.

### Distributed DADN

The functionality of any of the DADN controller components and/or functionalities may be combined, consolidated, and/or distributed in any number of ways to facilitate development and/or deployment. Similarly, the module collection may be combined in any number of ways to facilitate deployment and/or development. To accomplish this, one must simply integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load balancing data processing techniques. Furthermore, single instances may also be distributed across multiple controllers and/or storage devices; e.g., databases. All program module instances and controllers working in concert may do so through standard data processing communication techniques.

The preferred DADN controller configuration will depend on the context of system deployment. Factors such as, but not limited to, the capacity and/or location of the underlying hardware resources may affect deployment requirements and the final configuration. Regardless of whether the configuration results in more consolidated and/or integrated program modules, results in a more distributed series of program modules, and/or results in some combination between a consolidated and/or distributed configuration, communication of data may be communicated, obtained, and/or provided. Instances of modules (from the module collection) consolidated into a common code base from the program module collection may communicate, obtain, and/or provide data. This may be accomplished through standard data processing techniques such as, but not limited to: data referencing (e.g., pointers), internal messaging, object instance variable communication, shared memory space, variable passing, and/or the like (intra-application communication.

If module collection components are discrete, separate, and/or external to one another, then communicating, obtaining, and/or providing data with and/or to other module components may be accomplished through standard data processing techniques such as, but not limited to: Application Program Interfaces (API) information passage; (distributed) Component Object Model ((D)COM), (Distributed) Object Linking And Embedding ((D)OLE), and/or the like), Common Object Request Broker Architecture (CORBA), process pipes, shared files, and/or the like (inter-application communication). Messages sent between discrete module components for inter-application communication or within memory spaces of a singular module for intra-application communication may be facilitated through the creation and parsing of some grammar. The grammar may be developed by using standard development tools such as lex, yacc, and/or the like, which allow for grammar generation and parsing functionality, which in turn may form the basis of communication messages within and between modules. Again, the preferable embodiment will depend upon the context of system deployment.

Finally, it is to be understood that the logical and/or topological structure of any combination of the module collection and/or the present principles as described in the figures and throughout are not limited to a fixed execution order and/or arrangement, but rather, any disclosed order is exemplary and all functional equivalents, regardless of order, are contemplated by the disclosure. Furthermore, it is to be understood that such structures are not limited to serial execution, but rather, any number of threads, processes, services, servers, and/or the like that may execute asynchronously, simultaneously, synchronously, and/or the like are contemplated by the disclosure.

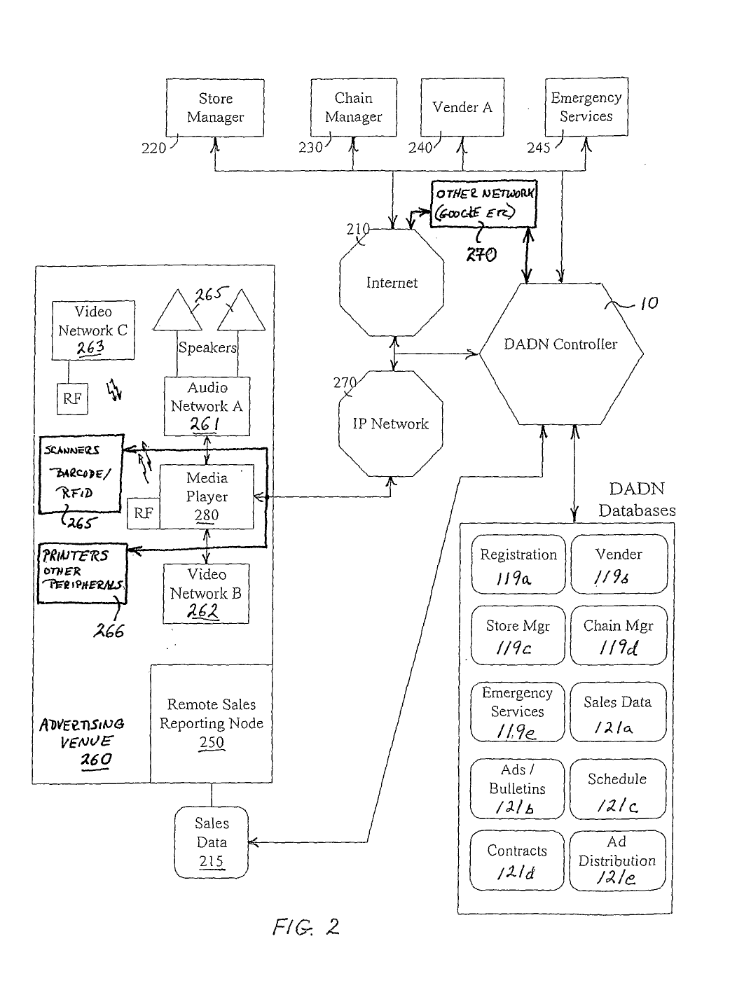

In the embodiment illustrated in FIG. 2, the DADN controller 10 is shown as a centrally located device that has the ability to process and coordinate information received over the Internet 210 with a Store Manager 220 and a Chain Manager 230. Additionally, the DADN controller 10 may be connected to a plurality of Vendors 240 and/or an Emergency Service Provider 245 directly and/or through the Internet 210 or any other network. The DADN controller 10 is also connected to a plurality of stores or other point of sale advertising venues 260 through an IP network 270. In addition, the DADN controller 10 can also be connected to third party sales networks and advertising or market place networks 270. Generally, the configuration allows the DADN controller 10 to receive sales data 215 transmitted by remote sales reporting nodes 250 in participating stores, and can also receive sales data from the third party networks 270, such as, for example GOOGLE. The sales information provided from the third party network can include product specific info, or may be less targeted and be product category based. At least one of the Store Manager 220, Chain Manager 230 and/or the collection of Vendors 240 may, in turn, analyze the sales data, attempting to correlate positive/negative sales data to the current advertising campaign.

According to one embodiment of the present principles the Store Manager 220 and the Chain Manager 230 (collectively “managers”) communicate with the DADN controller 10 through the Internet 210 by accessing a web site associated with the central server using a web-browser via an Internet Service Provider (“ISP”, not shown). Alternatively, the Store Managers 220 may review and/or manipulate distribution data through either an automated system or a live telephone operator who works with the users to customize their account to meet their needs.

### Emergency Service

In one embodiment, a registered member of an Emergency Service Provider 245 may access the system in order to issue a special bulletin or warning. It is to be understood that in this embodiment the Emergency Service Provider 245 may access the system to transmit a message regarding issues of importance in a similar manner to the Emergency Broadcast service's use of the television or radio networks. The Emergency Service User 245 can communicate with the DADN controller 10 via the Internet 210 by accessing a web site associated with the DADN controller as noted above. Emergency Service operational functionality will be discussed further with respect to FIG. 9.

### DADN Databases

It should be understood that the present principles are not limited to the databases illustrated in the figures and that databases could be modified, added, replaced or deleted without departing from the scope and spirit of the same.

In the exemplary embodiment illustrated in FIG. 6, a Registration database 119a tracks log-in names, passwords and other relevant information for identifying and authenticating registered users such as managers and advertisers into the Web site associated with the DADN controller 10. A Vendor information database 119b contains information relating to Vendors 240. Possible fields in this database include information associated with the Vendor 240 such as the contract type, deposited advertisements, associated product, current advertising locations, and corresponding sales data.

A Store Manager database 119c contains information relating to Store Managers 220. Possible fields in this database include information associated with the Store Manager 220 such as the contract type, deposited advertisements, associated product, current advertising locations, corresponding sales data and any restrictions for viewing or altering the aforementioned fields.

A Chain Manager database 119d contains information relating to Chain Managers 230. Possible fields in this database include information associated with the Store Manager 220 such as the contract type, deposited advertisements, associated product, current advertising locations, corresponding sales data and any restrictions for viewing or altering the aforementioned fields.

An Emergency Service database 119e contains information relating to Emergency Service Provider 245. Possible fields in this database include information associated with the Emergency Service Provider 245 such as the contract type, deposited messages, and current advertising locations.

A sales data database 121a contains data gathered by remote sales reporting nodes distributed throughout the Advertising Venues. The sales data may be sorted by product, Vendor, store, region, etc. . . . , in order for Vendors 240 and Managers 220 to easily analyze the data to discern any correlation between a certain product or line of products and the associated advertisements.

An advertisement or bulletin database 121b contains advertisements deposited by Vendors 240 and Managers, as well as, messages deposited by Emergency Services Provider 245. The advertisements stored in the database may be audio, video, or still picture advertisements. It is to be understood that the media stored in the database may contain, but is not limited to bulletins, messages and entertainment medium to be played by the media players.

A schedule database 121c contains information relating to the schedule of advertisements, bulletins, messages and other entertainment media to be played over the media players including the location (region, chain, store, etc.) and frequency of play. Venue specific available advertising slots are another possible field in this database.

A contracts database 121d includes various types of contracts associated with the Vendor 240, Store Manager 220, Chain Manager 230, or Emergency Service 245. Possible fields in this database include the amount of play time or frequency of play contracted for, number of advertisements and any specific scheduling requirements requested by the users.

Advertisement Distribution databases 121e includes tables associated with the different Advertising Venues that have registered with the system. The tables may include maps displaying the various advertising coverage areas, and the corresponding cost structures. It is to be understood that the stored maps may show other characteristics, for example the maps may be keyed by current coverage specific to an Advertiser or a plurality of Advertisers.

A plurality of Registered Advertising or other point of sale Venues 260 each may have a network of media players with audio and video capabilities. One possible embodiment of a media player network 280 is illustrated in FIG. 2. The DADN controller 10 is connected to media player 280 via IP network 270 with dialup, dedicated or wireless connectivity. Media player(s) 280 can have an internal inventory of advertisements, bulletins, messages, and other entertainment mediums and has the ability to convert files from the DADN controller 10 into audio and/or video feeds. In this particular exemplary embodiment, media player 280 is connected to three audio and video networks inside the store: audio network A 261, video network B 262, and video network C 263. Network A 261 consists of speakers 265 over which audio feeds are played. Audio Network A 261 is directly connected to media player 280. Video Network B 262 consists of a video player (not shown) and is directly connected to media player 280. Video Network C 292 consists of a video player (not shown) and is connected to media player 280 through wireless connectivity. Data is collected at remote sales reporting node (RSRN) 250 after items are scanned. The sales data 215 may be transmitted back to DADN 10, stored in the DADN Database modules, and analyzed by the user, i.e. Managers and Vendors, and/or Advertising Executives.

The media players 280 can also include interactive displays that either have corresponding keypads or touch screen interfaces. These interactive media players can be programmed to initiate customer responses and also allow consumers to view or request certain product information. The system can be responsive to the customer by providing more advertising for the customer chosen product or related products in the same category. Any customer input received through an interactive Media play 280 can be received and added to the SD database 121a and uses for later analysis.

According to other preferred embodiments, the sales advertising venue 260 may also include customer scanners 265 that can be of any suitable form. For example, the scanners 265 can be barcode or RFID scanners that can provide the customer with instant information and advertising specific to the product they scan with the scanner. The DADN controller 10 can retrieve this information from its own databases or its third party partner's databases and provide video or other promotional materials about such product or service. Through the addition of printers and/or other peripheral devices 266, scanable coupons can be printed at the point of sale. The printers/other peripherals 266 can also provide the customer with other outputs based on their interaction with the interactive display media player 280.

### Vendors' Activities

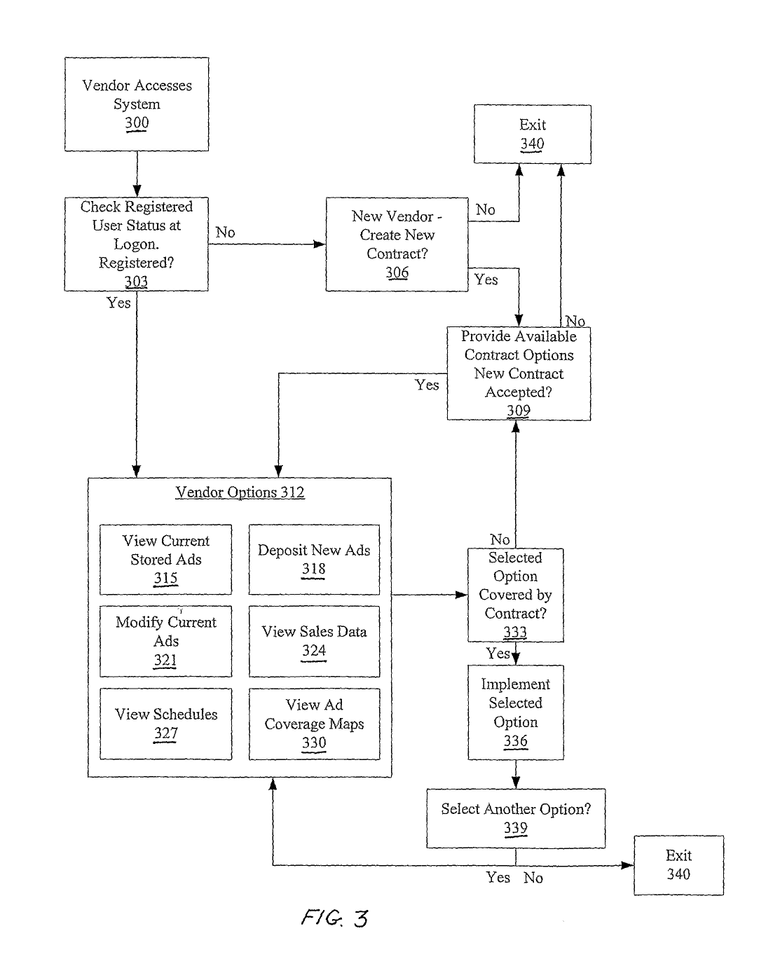

FIG. 3 is an exemplary diagram illustrating the various options presented to a Vendor 240 by the DADN 10. It is to be understood that a Vendor 240 illustrated in this embodiment may substituted with a Store Manager 220, a Chain Manager 230, or any other Advertiser. Vendors 240 may access the system through the Internet or directly through the DADN 10 in step 300. The DADN 10 determines if the Vendor 240 attempting to access the system has previously established a contract and is a registered user in step 303. Alternatively, new Vendors may create and accept an advertisement distribution contract via the internet in steps 306 and 309. If the Vendor 240 chooses not to enter into a contract in steps 306 and 309, the Vendor 240 may exit the system in step 340. The Vendor 240 may access the DADN 10 through the web page by using a log-in identifier to gain access to the system. Once a Vendor 240 has gained access to the central server 10, the DADN provides the user with a variety of available options vendor 312. For instance, a Vendor 240 may choose to view current advertisements deposited on the system 315. A Vendor 240 may deposit new advertisements on the system or modify currently stored advertisements 318, 321. A Vendor 240 may also view and analyze sales data collected from specific Registered Advertising Venues, since the remote Media Players have RSRNs transmitting the sales data back to the DADN 10 in option 324. After viewing the sales data, a Vendor 240 may decide to review and/or change the time, frequency and/or Registered Advertising Venues where the advertisement is distributed. 327, 330. It is to be understood that the vendor options list 312 is for exemplary purposes, and that other system parameters may be viewed, modified, and/or submitted. These changes made by the Vendor 240 may have an affect on the cost of the service provided. The DADN verifies that the selected services are covered by the Vendor's contract 333. In an alternate embodiment, steps 312 and 333 may be condensed into a signal step, wherein the DADN 10 only provides the Vendor 240 with options provided by the Vendor's contract. In a further embodiment, the DADN 10 may provide all system options to the Vendor, but distinguish between those that are currently covered by the Vendor's contract and those that are not. If the selected option is not covered by the Vendor's contract, the DADN 10 may send the Vendor to step 309 to work out the necessary modifications to the current contract. Otherwise, if the selected options are covered by the Vendor's contract in 333, the DADN will implement the selected option in step 336 and inquire if the Vendor 240 would like to select another option in step 339. If the Vendor wants to continue using the DADN, the system proceeds to step 312, illustrating the available options. Otherwise, the Vendor 240 may exit the system in step 340.

### Managers' Activities

The activities of Store Managers 220 and Chain Managers 230 will be substantially the same as the activities of Vendors. Managers may gain access to the system via an Internet web site. The ability of managers to change the content of advertisements or change the time, frequency and/or area(s) where the advertisement is distributed is likely to vary for each individual product line and/or associated Vendor, as it will depend on how much authority Vendors want to entrust to managers. Managers may have a larger role when the advertisement or promotion is specific to a given store or chain.

FIG. 8 is an exemplary operational diagram illustrating an embodiment of the relationship between a Vendor 240 the DADN 10, at least one remote Media Player 402, and the General Public 403. It is to be understood that the use of “Vendor” herein is by way of example only, and that the Vendor 240, may be substituted with a Store Manager, Chain Manager, and/or any other Advertising Entity. Remote Media Players 402 transmit advertisements according to a predetermined schedule 404. Vendor 240 initiates the process by attempting to log into the system 405. The DADN 10 will try to authenticate the Vendor's login account and password in response to the login attempt. Upon successful authentication, the DADN 10 will determine the level of access corresponding to the Vendor's account and proceed accordingly 408. After authentication, the DADN 10 may acknowledge 411 the Vendor's presence on the system and provide the Vendor 240 with a set of options, as discussed above. The Vendor 240 selects an option. For example, the Vendor 240 may select to modify schedule parameters for a previously stored advertisement 414. Through the DADN administration/scheduling software, the Vendor 240 selects the new time and location for distribution of the advertisement 417. The DADN 10 conducts the internal modifications within the DADN databases in step 420 and contacts the Remote Media Player 402 with the corresponding instructions for making the timing and location changes. 423. The Remote Media Player 402, in turn, processes the modification instructions, and modifies local scheduling parameters 426. The Remote Media Player 402 begins transmitting advertisements to the general public 403, in accordance with the new advertisement schedule 429. The DADN 10 may send a confirmation notice of the implemented change 432 to the Vendor. It is to be understood that in addition to a confirmation, other account parameters may be included in the notice, such as the nature of the current transaction, a listing of previous transactions, current contract status, and/or other items relating to the Vendor's account. After issuing the confirmation, the DADN may inquire if the Vendor would like to conduct any additional transactions. 435

### Emergency Services' Activities

FIG. 9 illustrates an embodiment of the present invention in which an Emergency Services group such as the National Weather Service 500 may use the system to issue an Emergency message or bulletin based on an emergency situation. By way of example only, in FIG. 9 the National Weather Service 500 determines the need to issue a Severe Weather Warning for New York City 505. A Remote Media Player 402 displays advertisements according to a predetermined schedule to the General Public 403 in step 506. The National Weather Service user 500 logs in 508 to the DADN 10. Accordingly, the DADN 10 will verify the authenticity of the National Weather Service user 500 in step 511. After the user 500 is authenticated, the user 500 is given access to the Emergency Services functionality associated with the DADN 10 in step 514. The user may search through stored messages in the DADN database modules at step 517A. Alternatively, the user 500 may modify a stored message or transmit a new message detailing the specifics of the emergency situation 517B. The user 500 then designates a distribution at step 520 for the emergency bulletin, from maps illustrating the DADN coverage area. After the user 500 selects the message and distribution area, the DADN 10 overrides the scheduled advertisement display and sends the National Weather Service Bulletin to the Remote Media Players 502 located across the DADN 10 in the user-designated distribution area in step 523. The Remote Media Players 502 process the DADN override instruction and receives the emergency bulletin. Accordingly, the remote Media Players transmit the emergency bulletin to the general viewing public 503 in step 526. Upon confirmation of the transmission of the initial emergency bulletin, the DADN 10 then asks the user how they would like to proceed at step 529. The user 500 may select from various options, some of which may include: rescheduling the transmission of the same initial emergency bulletin at a periodic interval, scheduling period transmissions for new bulletins containing updated information, or arranging an open data channel for continuous streaming updates. In accordance with the user's selection in step 532, the DADN 10 executes the program modules that accomplish the selected course of action at step 535. The remote Media Players transmit any further emergency bulletins accordingly 538. In an alternate embodiment, the Emergency Service Provider 250 may be under a contract to use the system similar to Vendors 240. The options available to Emergency Service Provider 250 are substantially similar to those available to Vendors 240.

It should be understood that the above description is only representative of illustrative embodiments. For the convenience of the reader, the above descriptions have focused on a representative sample of all possible embodiments, a sample that teaches the principles of the invention. The description has not attempted to exhaustively enumerate all possible variations. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that the embodiments and variations shown and described herein are merely illustrative of the principles of this invention and that various modifications may be implemented without departing from the scope and spirit of the present principles.

What is claimed is:

1. A method for dynamic advertisement delivery comprising:
receiving at least one advertisement from an advertiser;
storing the advertisement on a system;
providing the advertiser access to the system, wherein the advertiser designates advertisement distribution characteristics associated with at least one registered advertising venue for any advertisement submitted by the advertiser;
distributing the at least one advertisement according to the designated distribution characteristics; and
collecting sales data from the advertising venues in a remote sales reporting node corresponding to the distributed advertisements associated with the advertiser, wherein said remote sales reporting node transmits the collected sales data back to the system in real time.

2. The method of claim 1, further comprising transmitting unprocessed sales data back to the system by the remote sales reporting node.

3. The method of claim 1, further comprising transmitting processed sales data reports back to the system by the remote stales reporting node.

4. The method of claim 1, wherein said distributing further comprises providing at least one media player within each advertising venue, said at least one media player being networked with the advertisement delivery system and having at least one audio and/or video unit.

5. The method of claim 4, further comprising providing a media player having an interactive device capable of receiving customer input.

6. The method of claim 5, wherein the media player is capable of converting files into audio and/or video data feeds.

7. The method of claim 6, wherein advertisements are transferred from the system to media players and stored locally for distribution.

8. The method of claim 7, wherein the media player is capable of either receiving a distribution parameter update from the system or initiating a request for a distribution parameter update.

9. The method of claim 5, further comprising:
connecting an emergency services group to the system, and
distributing an emergency bulletin to all media players connected to the system.

10. The method of claim 9, further comprising specifying a geographic distribution area for distribution area of the emergency bulletin, said specifying performed by the emergency service group.

11. The method of claim 1, further comprising collecting sales data from third party networks connected to the system, and analyzing said third party network sales data either combined with or separately from the sales data provided by the remote sales reporting node.

12. A method for dynamic advertisement delivery and advertising inventory management comprising:
receiving a plurality of advertisements from advertisers;
managing store advertising inventory from a centralized location;
playing the advertisement within one or more participating stores;
collecting point of sale information from the participating stores in real time; and
correlating customer checkout information to advertisements played within the participating store, and modifying the playing of advertisements based on said checkout information in real time

13. The method of claim 12, further comprising providing at least one media player within the store, said media players having a network of audio and video players located in stores and consumer purchase areas, said media players being connected to a central server via an IP network with dialup, dedicated or wireless connectivity.

14. The method according to claim 12, wherein said playing comprises at least one of displaying advertisements in all participating stores, in stores in a particular region, in a particular chain of stores, in a particular store, in a particular department or aisle of a store, or a combination of one or more of the above.

15. A system for dynamic advertisement delivery and advertising inventory management comprising:
a dynamic advertisement delivery network controller (DADN) (10);
a plurality of advertising buyers connected to the dynamic advertisement delivery network controller;
a plurality of advertising venues (260) connected to the dynamic advertisement delivery network controller (10) and providing advertising space for sale to advertising buyers;
at least one remote sales reporting node (250) in each of the advertising venues connected to the dynamic advertisement delivery network for reporting real time sales information to the DADN controller;
a sales data analysis module (120) within the DADN controller (10) and adapted to analyze sales data in real time and provide feedback to the advertising buyers and sellers also in real time to enable the buyers to dynamically change or alter their advertisements.

16. The system according to claim 15, further comprising at least one media player (280) in each of said plurality of advertising venues, said at least one media player having at least one video and/or audio network for displaying the advertising to the customers

17. The system according to claim 16, wherein the advertising buyers are connected to the DADN controller via a global network of computers, such as the internet.

18. The system according to claim 17, wherein the advertising venues (260) are connected to the DADN controller via an IP network (270).

19. The system according to claim 16, further comprising customer scanners (265) in each of the advertising venues, said scanners in communication with the DADN controller (10) and said at least one remote sales reporting node (250), said scanners providing additional information to the customers relating to a particular scanned product.

20. The system according to claim 16, further comprising printers (266) in each of the advertising venues (260), said printers connected to the DADN controller (10) and adapted to provide printed advertisements, coupons or other promotional information to the customer in response to

21. The system according to claim 16, wherein said advertising venues include managers and/or advertising promotion managers that are connected to the DADN controller through a global network of computers such that they may dynamically change any promotion and/or advertising space display in substantially real time based on the feedback provided by the remote sales reporting nodes.

22. The system according to claim 16, further comprising an emergency service provider (245) connected to the DADN controller (10), said DADN controller enabling broadcast of emergency service notifications on one or more media players contained with in one or more of the plurality of advertising venues.

23. The system according to claim 16, wherein said DADN controller further comprises a plurality of databases (119, 121) corresponding to at least one of sales data, advertising scheduling, advertising contracts, emergency services, advertisements, advertising buyers and advertising buyer registration information.

24. The system according to claim 16, wherein said DADN controller further comprises: user input (111) control to enable advertising buyers to change or modify the content of advertisements, bulletins and messages, the time of play, frequency of play, and the area of play by a direct connection to the DADN controller via the Internet.
